(19) United States
(12) Patent Application Publication
(10) Pub. No.: US 2023/0354420 A1
(43) Pub. Date: Nov. 2, 2023

(54) SIDELINK TRANSMISSION OVER UNLICENSED BANDS BETWEEN TRANSMITTING AND RECEIVING DEVICES

(71) Applicant: MEDIATEK INC., Hsinchu (TW)

(72) Inventors: Jing-Wei CHEN, Hsinchu (TW); Tao CHEN, Beijing (CN); Lung-Sheng TSAI, Hsinchu (TW)

(73) Assignee: MEDIATEK INC., Hsinchu (TW)

(21) Appl. No.: 18/307,168

(22) Filed: Apr. 26, 2023

(30) Foreign Application Priority Data
Apr. 28, 2022 (WO) PCT/CN2022/089978
Apr. 20, 2023 (CN) 202310426502.X

(51) Int. Cl. H04W 74/08; H04W 72/25; H04W 72/1263; H04W 72/51; H04W 72/542

(52) U.S. Cl. CPC H04W 74/0808; H04W 72/25; H04W 72/1263; H04W 72/51; H04W 72/542

(57) ABSTRACT

A method is provided, which includes conducting, at a first user equipment (UE), a listen-before-talk (LBT) process on an unlicensed band to obtain a channel occupancy time (COT) for a sidelink transmission; determining, at the first UE, based on channel sensing executed on the unlicensed band, a group of candidate sidelink resources on the unlicensed band, where each candidate side link resource is within a sidelink resource selection window, and does not have reservation that is associated with a Reference Signal Received Power (RSRP) higher than a predetermined resource exclusion RSRP threshold; selecting, at the first UE, a sidelink resource from the group of candidate sidelink resources; and performing, on the selected sidelink resource, the sidelink transmission from the first UE to a second UE, within the obtained COT. Multiple Sidelink Control Information (SCI) messages are decoded at the first UE on a single Physical Sidelink Control Channel (PSCCH) resource.

### INCORPORATION BY REFERENCE

This present application claims the benefit of Chinese Application No. 202310426502.X, filed on Apr. 20, 2023, which claims the benefit of International Application No. PCT/CN2022/089978. The disclosures of all prior applications are incorporated herein by reference in their entirety.

### TECHNICAL FIELD

The present disclosure relates to wireless communications and specifically relates to sidelink communications over unlicensed bands.

### BACKGROUND

User demands on cellular system throughput are increasing every year. Cellular systems typically operate in a licensed spectrum, which is expensive, scarce, and bandwidth-limited. Therefore, one of the most promising approaches to increase the throughput of cellular networks is to utilize free unlicensed frequencies for data transmission.

### SUMMARY

Aspects of the disclosure provide a method including: conducting, at a first user equipment (UE), a listen-before-talk (LBT) process on an unlicensed band to obtain a channel occupancy time (COT) for a sidelink transmission; determining, at the first UE, based on channel sensing executed on the unlicensed band, a group of candidate sidelink resources on the unlicensed band, where each candidate side link resource is within a sidelink resource selection window, and does not have reservation that is associated with a Reference Signal Received Power (RSRP) higher than a predetermined resource exclusion RSRP threshold; selecting, at the first UE, a sidelink resource from the group of candidate sidelink resources; and performing, on the selected sidelink resource, the sidelink transmission from the first UE to a second UE, within the obtained COT. Multiple Sidelink Control Information (SCI) messages are decoded at the first UE on a single Physical Sidelink Control Channel (PSCCH) resource.

In an embodiment, the method also includes: receiving, from the second UE, an SCI decoding capability of the second UE; and determining, based on the received SCI decoding capability of the second UE, at least one of a size of the sidelink resource selection window and a value of the RSRP threshold.

In an embodiment, the higher the SCI decoding capability of the second UE is, the narrower the size of the sidelink resource selection window is, and the higher the SCI decoding capability of the second UE is, the higher the value of the RSRP threshold is.

In an embodiment, the reported SCI decoding capability is indicated by one of: a maximum SCI decoding number of the second UE per PSCCH resource, a maximum number of SCIs for decoding per slot, a maximum number of SCIs for decoding per symbol, a maximum number of SCIs for decoding per sub-channel, a maximum number of SCIs for decoding per resource pool, a maximum number of SCIs for decoding per bandwidth part (BWP), a maximum number of SCIs for decoding per band, a maximum SCI decoding number of the second UE per link pair, and a maximum SCI decoding number of the second UE per receiving device.

In an embodiment, the decoding of the multiple SCI messages further includes decoding the multiple SCI messages in an order of signal strength, such that an SCI message with a higher signal strength is decoded before an SCI message with a weaker signal strength.

In an embodiment, the method also includes: decoding, at the first UE, multiple SCI messages on a single PSCCH resource, to collect resource reservation information from nearby sidelink UEs; generating, at the first UE, selection assistance information, based on the collected resource reservation information; and reporting, from the first UE to a third UE, the generated selection assistance information for a sidelink reception from the third UE.

In an embodiment, the generating step further includes generating, at the first UE, an indication of a preferred resource, as the generated selection assistance information, and the preferred resource is a resource that is identified, based on the collected selection assistance information, as preferred by the first UE for the sidelink reception.

In an embodiment, the generating step further includes generating, at the first UE, an indication of a non-preferred resource, as the generated selection assistance information, and the non-preferred resource is a resource that is identified, based on the collected resource reservation information, as not preferred by the first UE for the sidelink reception.

In an embodiment, the generating step further includes generating, at the first UE, an indication of a collided resource, as the generated selection assistance information, and the collided resource is a resource that is identified, based on the multiple SCI decoded on the PSCCH resource, as having a collision when the sidelink reception from the third UE is performed thereon.

In an embodiment, the method of claim also includes: receiving from the second UE, a report of selection assistance information indicating a preferred resource, a non-preferred resource, and/or a potentially collided resource; and selecting, at the first UE, the sidelink resource from the group of candidate sidelink resources, based on the reported selection assistance information.

In an embodiment, the determining step further includes: executing, at the first UE, the channel sensing by decoding the multiple SCI messages on the single PSCCH resource, to collect resource reservation information from nearby sidelink UEs, and determining, at the first UE, based on the collected resource reservation information, the group of candidate sidelink resources.

In an embodiment, the executing step further includes decoding the multiple SCI messages in an order of signal strength, such that an SCI message with a higher signal strength is decoded before an SCI message with a weaker signal strength.

In an embodiment, the method also includes receiving, from the second UE, an SCI decoding capability of the second UE; and choosing, at the first UE, based on the received SCI decoding capability and a priority level of the sidelink transmission to be performed, a collided resource, as the selected sidelink resource, where the collided resource is reserved by a nearby sidelink UE.

Aspects of the disclosure also provide an apparatus including circuitry configured to: conduct, at a first user equipment (UE), a listen-before-talk (LBT) process on the unlicensed band to obtain a channel occupancy time (COT) for a sidelink transmission; determine, at the first UE, based on channel sensing executed on an unlicensed band, a group of candidate sidelink resources on the unlicensed band, where each candidate side link resource is within a sidelink resource selection window, and does not have reservation that is associated with a Reference Signal Received Power (RSRP) higher than a predetermined resource exclusion RSRP threshold; select, at the first UE, a sidelink resource from the group of candidate sidelink resources; and perform, on the selected sidelink resource, the sidelink transmission from the first UE to a second UE, within the obtained COT. Multiple Sidelink Control Information (SCI) messages are decoded at the first UE on a single Physical Sidelink Control Channel (PSCCH) resource.

Aspects of the disclosure also provide a non-transitory computer-readable medium storing instructions. The instructions, when executed by a processor, can cause the processor to perform the above method.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an example of a Type 1 listen-before-talk (LBT) process 100 according to some embodiments of the disclosure;

FIG. 2 shows an LBT duration 200 of a Type 1 LBT process followed by a channel occupancy time (COT) duration 213;

FIG. 3 shows an example of Mode 2 resource allocation according to some embodiments of the disclosure;

FIG. 4 shows an example of sidelink transmission between a transmitting device 420 and a receiving device 410 according to some embodiments of the disclosure;

FIG. 5 shows an example of sidelink transmission between a transmitting device 520 and a receiving device 510 according to some embodiments of the disclosure;

FIG. 6 shows an example of sidelink transmission between a transmitting device 620 and a receiving device 610 according to some embodiments of the disclosure;

FIG. 7 shows an example of sidelink transmission between a transmitting device 720 and a receiving device 710 according to some embodiments of the disclosure;

FIG. 8 shows an exemplary method 800 according to some embodiments of the disclosure; and

FIG. 9 shows an exemplary apparatus according to some embodiments of the disclosure.

### DETAILED DESCRIPTION OF EMBODIMENTS

### I. Sidelink Over Unlicensed Spectrum (SL-U)

A user equipment (UE) can perform sidelink (SL) transmission over an unlicensed band. For example, the UE can perform sidelink sensing, sidelink resource selection, and sidelink transmission while performing a channel access process, such as a listen-before-talk (LBT) process. The unlicensed band can already be occupied, for example, by Wi-Fi networks. The channel access process can satisfy the regulation requirements such that different radio access technologies (RATs) can fairly share the unlicensed band.

For example, a process of SL device to transmit on an unlicensed band can be performed as follows. The SL device (SL UE) obtains a SL sensing window configuration from a network. For example, during a sensing process, the SL device senses and decodes SL control information (SCI) on physical sidelink control channel (PSCCH) resources within a SL sensing window. Based on sensing results from the sensing process, the SL device can determine a candidate sidelink resource set. The SL device performs SL resource selection on the candidate sidelink resource set to select and reserve transmission opportunities (or transmission resources). The SL device can acquire one or more channel occupancy times (COTs) by triggering one or more LBT process. The SL device transmits on the selected/reserved transmission opportunities within the COTs.

Operation methods for SL devices to transmit on an unlicensed band are disclosed. In the operation methods, regulation requirements for operating on an unlicensed band (including LBT process to acquire COT) are satisfied, while SL resource allocation rules are respected. The techniques disclosed herein address the following issues: (i) LBT category and process adopted by a SL device to access an unlicensed-band channel; and (ii) sidelink over unlicensed spectrum (SL-U) operation combining an LBT process and a SL resource allocation scheme. The SL resource allocation scheme can be similar to, for example, sidelink resource allocation Mode 2 specified in the standard specification developed by the 3rd Generation Partnership Project (3GPP). In the disclosure, examples of the LBT category and the corresponding channel access process are described. Examples of a baseline operation of a SL device accessing an unlicensed band channel based on an LBT process and SL resource allocation Mode 2 are described.

In some embodiments, the LBT category and process adopted by SL devices can be similar to New Radio (NR) uplink (UL) shared spectrum channel access process Type 1 or Type 2. In some embodiments, SL transmission based on LBT process can have two scenarios:
(Scenario 1) Obtain an initial COT for transmission.
(Scenario 2) Share COT from other SL devices.

For example, in an Out-of-COT operation, an initial COT can be obtained for transmission. SL devices can apply the Out-of-COT LBT to obtain an initial COT. For example, a Type-1 LBT (CAT4 LBT) can be applied. The Type 1 LBT can be an LBT process with a random back-off and a variable extended clear-channel assessment (CCA) period. For example, the initial value of a count-down timer (or counter) used in the random back-off can be randomly drawn from a variable-sized contention window. The size of the contention window can vary based on channel dynamics.

For example, in an In-COT operation, a SL UE can share a COT from other SL devices, or share a COT for multiple SL transmissions. SL devices can apply an In-COT LBT to share a COT. In some examples, the In-COT LBT type can be determined up to an indication of a COT owner. In some examples, the In-COT LBT type can be determined to be a Type 1 LBT (i.e., with a random backoff). In some examples, the In-COT LBT type can be determined up to the transmission gap. For example, Type 2A/2B/2C LBT (i.e., without random backoff) can be used.

### II. Channel Access Process Based on LBT Mechanism

LBT-based channel access process (LBT process) and related parameters are introduced below according to embodiments of the disclosure.

In the present disclosure, a channel refers to a shared spectrum (such as an unlicensed band) including radio resources on which a channel access process is performed. A channel access process (such as an LBT process) can be based on sensing that evaluates the availability of a channel for performing transmissions. The basic unit for sensing can be a sensing slot Tₛₗ. For example, a sensing slot can have a duration Tₛₗ=9 μs. The sensing slot duration Tₛₗ is considered to be idle if a UE senses the channel during the sensing slot duration, and determines that the detected power, for example, for at least 4 μs within the sensing slot duration is less than an energy detection threshold X_{Thresh}. Otherwise, the sensing slot duration Tₛₗ is considered to be busy.

A channel occupancy refers to transmission(s) on channel(s) by UE(s) after performing the corresponding channel access processes. A Channel Occupancy Time (COT) refers to the total time for which a UE and any UE sharing the channel occupancy perform transmission(s) on a channel after the corresponding channel access processes. In some examples, for determining a COT, if a transmission gap is less than or equal to, for example, 25μs, the gap duration is counted in the channel occupancy time. A channel occupancy time can be shared for transmission between UE(s).

In some examples, a SL transmission burst is can be a set of transmissions from a UE without any gaps greater than a predefined threshold, such as 16 μs. Transmissions from a UE separated by a gap of more than the predefined threshold can be considered as separate SL transmission bursts. A UE can transmit transmission(s) after a gap within a SL transmission burst without sensing the corresponding channel(s) for availability.

In some examples, SL transmission(s) are performed according to one of Type 1 or Type 2 SL channel access processes (Type 1 or Type 2 SL LBT processes). For Type 1 SL channel access process (Type 1 LBT), the time duration spanned by the sensing slots that are sensed to be idle before a SL transmission(s) is random. In some examples, a SL UE may perform Type 1 channel access process as follows. The SL UE may first sense the channel to be idle during the sensing slot durations of a defer duration T_{d}. Then, the SL UE may perform the following steps: 1) set N=Nᵢₙᵢₜ, where Nᵢₙᵢₜ is a random number uniformly distributed between 0 and CWₚ (a contention window), and go to step 4; 2) if N>0 and the UE chooses to decrement the counter, set N=N−1;3) sense the channel for an additional sensing slot duration, and if the additional sensing slot duration is idle, go to step 4; else, go to step 5; 4) if N=0, stop; else, go to step 2. 5) sense the channel until either a busy sensing slot is detected within an additional defer duration T_{d} or all the sensing slots of the additional defer duration T_{d} are detected to be idle; 6) if the channel is sensed to be idle during all the sensing slot durations of the additional defer duration T_{d}, go to step 4; else, go to step 5.

In some examples, the SL UE may transmit a transmission on the channel, if the channel is sensed to be idle at least in a sensing slot duration Tₛₗ when the UE is ready to transmit the transmission and if the channel has been sensed to be idle during all the sensing slot durations of a defer duration T_{d} immediately before the transmission. In some examples, the defer duration T_{d} includes duration T_{f}=16 μs immediately followed by mₚ consecutive sensing slot durations. For example, each sensing slot duration is Tₛₗ=9 μs. For example, T_{f}=16 μs. T_{f} includes an idle sensing slot duration Tₛₗ at start of T_{f}.

In some examples, the contention window size CWₚ can be selected from a range, such as CW_{min,p}≤CWₚ≤CW_{max,p}. For example, CWₚ adjustment can be based on a channel loading status. The lower and upper limits of the contention window size, CW_{min,p} and CW_{max,p}, can be chosen before step 1 of the process above. The parameters mₚ, CW_{min,p}, and CW_{max,p} can be determined based on a channel access priority class (CAPC) p associated with the current SL transmission(s). A COT of the current SL transmission(s) can also be determined based on the CAPC. An example of SL LBT process parameters associated with CAPC is shown in Table 1.

TABLE 1

| Channel Access | | | | | |
|---|---|---|---|---|---|
| Priority Class | | | | | |
| (p) | mₚ | CW_{min, p} | CW_{max, p} | T_{maximum cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, 255, 511, 1023} |
| 4 | 7 | 15 | 1023 | 6 ms or 10 ms | {15, 31, 63, 127, 255, 511, 1023} |

For Type 2 SL channel access process (Type 2 LBT process), the time duration spanned by the sensing slots that are sensed to be idle before a SL transmission(s) can be deterministic. In some examples, for a Type 2A SL channel access process (Type 2A SL LBT process), a SL UE may transmit the transmission immediately after sensing the channel to be idle, for example, for at least a sensing interval T_{short_ul}=25 μs. T_{short_ul} can include a duration T_{f}=16 μs immediately followed by one sensing slot. T_{f} includes a sensing slot at start of T_{f}. The channel is considered to be idle for T_{short_ul} if both sensing slots of T_{short_ul} are sensed to be idle.

In some examples, for Type 2B SL channel access process (Type 2B SL LBT process), a UE may transmit the transmission immediately after sensing the channel to be idle within, for example, a duration of T_{f}=16 μs. T_{f} includes a sensing slot that occurs within the last 9 us of T_{f}. The channel is considered to be idle within the duration T_{f} if the channel is sensed to be idle for total of at least 5 us with at least 4 us of sensing occurring in the sensing slot, for example. In some examples, for Type 2C SL channel access process (Type 2C SL LBT process), a UE does not sense the channel before the transmission. The duration of the corresponding UL transmission is, for example, at most 584 us.

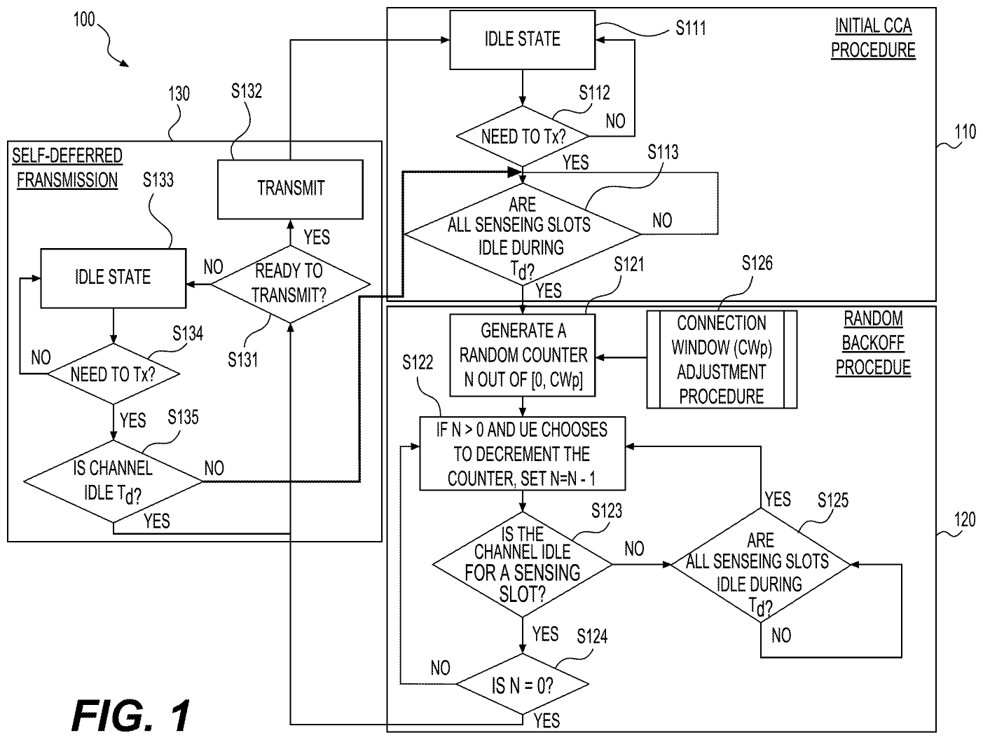

FIG. 1 shows an example of a Type 1 LBT (CAT4 LBT) process 100 according to embodiments of the disclosure. The process 100 can include 3 individual parts forming a loop: an initial clear channel assessment (CCA) process (or procedure) 110, a random backoff process (or procedure) 120, and a self-deferred transmission 130. A UE can perform the process 100 to access a sidelink channel on an unlicensed band. The process 100 can start from S111.

At S111, the UE can operate in an idle state. At S112 whether a transmission is to be performed is determined. If so, the process 100 proceeds to S113. Otherwise, the process 100 returns to S111. At S113, the UE sense whether the channel is idle during the sensing slot durations of a defer duration T_{d}. If the channel is idle for all the sensing slots, the process 100 proceeds to S121 and enters the random backoff process 120. Otherwise, the process 100 repeats the operations of S113.

At S121, the UE generates a random counter value N out of a contention window between 0 and CWₚ. A contention window adjustment process (or procedure) S126 may be performed at S121 based on a channel loading status. At S122, the UE may decrement the counter by 1. At S123, the UE performs a sensing of the channel for a sensing slot. If the channel is idle for the sensing slot, the process 100 proceeds to S124. Otherwise, the process 100 proceeds to S125. At S125, the UE repeatedly performs channel sensing during a differ duration T_{d} until the channel is idle. Then, the process 100 returns to S122. At S124, if the counter value equals 0, the process proceeds to S131 and enters the self-deferred transmission 130. Otherwise, the process returns to S122.

At S131, whether the UE is ready to transmit a transmission is determined. If so, the process 100 proceeds to S132. Otherwise, the process 100 proceeds to S133. At S133, the UE can operate in an idle state. At S114, whether a transmission is to be performed is determined. If so, the process 100 proceeds to S135. Otherwise, the process 100 returns to S133. At S135, the UE senses the channel during sensing slots of a defer duration T_{d}. If the channel is idle during the defer duration T_{d}, the process 100 proceeds to S131. Otherwise, the process returns to S113.

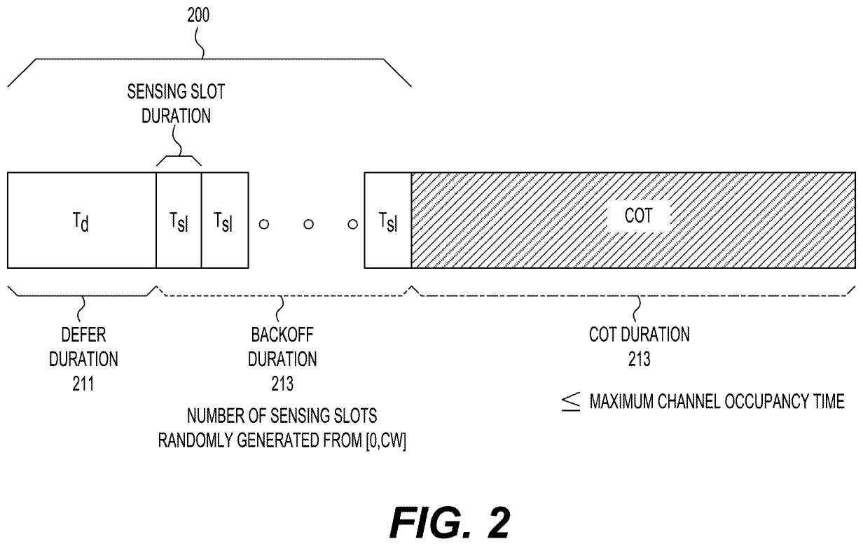

FIG. 2 shows an LBT duration 200 of a Type 1 LBT process followed by a COT duration 213. As shown, the LBT duration can include 2 portions: a defer duration 211 and a backoff duration 212. The variables to determine LBT duration 200 and COT duration 213 can be configured according to a priority class. For example, the backoff duration 212 can determined based on a number of sensing slots randomly generated from a contention window (CW). The size of the contention window can be determined based on a priority class of the related SL transmission (e.g., CAPC). The COT duration 213 is bounded by a maximum channel occupancy time T_{maximum cot}. The maximum channel occupancy time T_{maximum cot} can also be determined based on the priority class of the related SL transmission (e.g., CAPC).

In the FIG. 2 example, the minimum length of time taken by an LBT process can be the summation of the defer duration 211 (Td) and the backoff duration 212 (sensing slots duration). The number of sensing slots, denoted by N, can be randomly rolled between 0 and a CW size. Accordingly, in some examples, an LBT duration (or LBT time) can be expressed as follows,

LBT duration (LBT time)=Td+Tsl*N.

### III. Sidelink Mode 2 Resource Allocation

The process and parameters of SL channel sensing and resource selection in resource allocation Mode 2 are introduced below according to embodiments of the disclosure.

In some examples, physical sidelink control channel (PSCCH) and physical sidelink shared channel (PSSCH) resources can be defined within a resource pool for the respective channel. A SL UE can make resource selections based on sensing within the resource pool. A resource pool can be divided into sub-channels in the frequency domain. Resource allocation, sensing, and resource selection can be performed in units of a sub-channel. There can be two SL resource allocation modes: Mode 1 and Mode 2 in various embodiments. Mode 1 can be used for resource allocation by a base station (BS). Mode 2 can be for UE autonomous resource selection (without involvement of a BS).

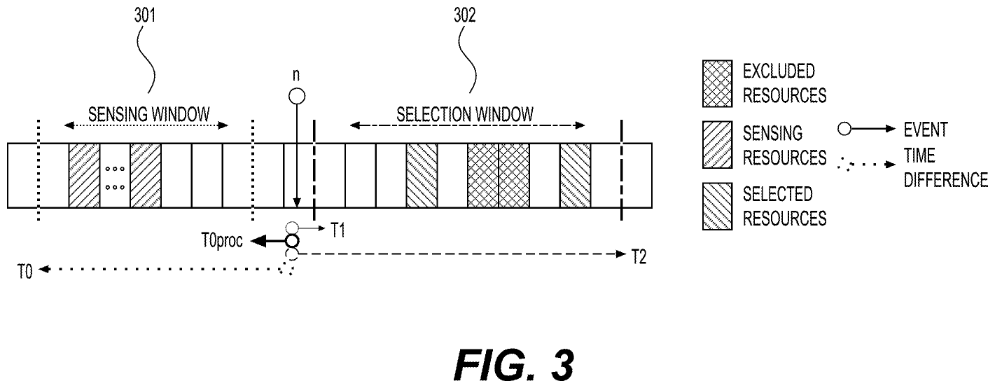

FIG. 3 shows an example of Mode 2 resource allocation according to some embodiments of the disclosure. A UE performs sensing within a (pre-)configured resource pool to know which resources are not in use by other UEs with higher-priority traffic. Accordingly, the UE can select an appropriate amount of such resources for transmissions. The UE can transmit and retransmit a certain number of times on the selected resources.

For example, resource reservation information can be carried in a sidelink control information (SCI) (such as a first stage SCI) scheduling a current transport block. The SCI may be carried in a PSCCH. A sensing UE can monitor a sensing window 301 to decode other UEs' PSCCHs to obtain which resources have been reserved. The sensing UE can also measure SL reference signal received power (SL-RSRP) in the slots of the sensing window 301. In this way, the sensing UE can collect the sensing information including reserved resources and SL-RSRP measurements associated with the sensing window 301. For example, a traffic arrival or a re-selection trigger may takes place in slot n. The sensing window 301 can start at slot [n−T0] in the past and finishes at slot [n−T0proc], shortly before slot n. For example, the sensing window 301 can be 1100 ms or 100 ms wide. The 100 ms option can be used for aperiodic traffic. The 1100 ms option can be used for periodic traffic.

The sensing UE can then select resources for (re-)transmission(s) from within a selection window 302. For example, the selection window 302 can start at slot [n+T1], shortly after the trigger for (re-)selection of resources, and finish at slot [n+T2]. T2 cannot be longer than the remaining latency budget of the packet due to be transmitted. Reserved resources in the selection window with SL-RSRP above a threshold can be excluded from being candidates by the sensing UE. The threshold can be set according to the priorities of the traffic of the sensing and transmitting UE. For example, a higher-priority transmission from a sensing UE can occupy resources that are reserved by a transmitting UE with sufficiently low SL-RSRP and sufficiently lower-priority traffic.

In some examples, the UE can select an appropriate amount of resources randomly from this non-excluded set. The resources selected in general are not periodic. Up to three resources can be indicated in each SCI transmission. Those resources can each be independently located in time and frequency. In some cases, the indicated resources can be reserved for semi-persistent transmission of another transport block(s). In some examples, shortly before transmitting in a reserved resource, a sensing UE re-evaluates the set of resources from which it can select, to check whether its intended transmission is still suitable. For example, late-arriving SCIs may indicate an aperiodic higher-priority service starting to transmit after the end of the original sensing window. If the reserved resources would not be part of the set for selection, then new resources are selected from the updated resource selection window.

### IV. Sidelink UE Operation Design

### 1. Problems and Key Issues

In various embodiments, the sidelink UE operation can be designed to address the scenario where a sidelink device acquires an initial COT for transmission and obtains transmission resource by sidelink resource allocation Mode 2. The 3GPP TS 38.214 provide further examples of sidelink resource allocation Mode 2. For SL UE operation, two expected behaviors can be:
SL device performs a Type-1 LBT (LBT CAT4) procedure to acquire a COT for transmission;
SL device follows the SL resource allocation Mode 2 to perform SL sensing and resource selection.

In some embodiments, to combine the SL resource allocation Mode 2 and the LBT process together, the following four problems are identified.

### 1) Significant Transmission Delay

Performing SL resource selection requires a random resource selection behavior within an SL selection window. However, a larger selection window length results in increased transmission latency. Additionally, to improve packet decoding success ratio and reduce interference, a large selection window is necessary to obtain more candidate resource options and avoid collided transmission slots.

Therefore, using both an LBT random backoff window and a large SL selection window length with collision avoidance mechanism can cause a significant transmission delay.

### 2) Hidden Node Problem

While the LBT procedure and the SL resource selection can help reduce potential interference and ensure a clean channel during transmission, the “hidden node” problem cannot be completely eliminated.

For example, during channel sensing, it may be difficult for a transmitting UE to detect all sources that could potentially cause interference to the receiving UE, leaving some nodes undetected. As the result, transmission can still collide with transmissions between these hidden nodes and the receiving UE, leading to decoding failure.

### 3) Uncoordinated Serving of SL UE Operation

In one common SL UE operation scenario, an Internet-of-Things (IoT) device is served by another device owned by the same user. For example, a user's smart watch is normally served by his or her own smart phone. In such cases, the SL serving pairing is not based on the best serving link quality between the two devices, but on the fact that both devices belong to the same owner.

However, when the serving RSRP of such a serving SL pair is low, for example, an uncoordinated serving problem may occur. That is, transmissions within the serving pair can be easily overpowered by nearby SL transmissions that have better serving link quality.

### 4) Inapplicability of HARQ Retransmission on Control Channel Transmission

The Hybrid Automatic Repeat Request (HARQ) retransmission mechanism can be used to ensure that data is reliably transmitted even in noisy and interference-prone environments. However, this mechanism is not applicable to control channel transmission.

In one scenario, for example, a transmitting UE's SCI message may collide with an SCI transmitted on the same resource by an interfering device. The interfering SCI may have a higher power at the receiving UE side. The receiving UE's blindly decoding the control signal with the higher power can lead to the decoding failure of the desired SCI. As the HARQ mechanism cannot remedy the failure of the control channel transmission, the decoding failure of the desired control signal will ultimately result in the failure to decode the data channel.

### 2. Solutions

In sidelink communication, it is common for the transmitting UE and the receiving UE to sense and decode only one SCI message on a control channel resource, though there may exist multiple SL UEs transmitting their own SCI messages on the same control channel resource. Given a limited decoding capability of SL UEs, normally they decode only the SCI message with the strongest power on a control channel resource, while ignoring SCI messages with weaker power levels.

To cope with the above-mentioned problems, a multiple SCI sensing/decoding approach is adopted in various embodiments. The following features can be combined to offer advantages over the conventional approaches.

### 1) Multiple SCI Decoding Operation

At least one of the transmitting and receiving UE can decode multiple SCI messages on a single PSCCH resource. The maximum number of the SCI messages decoded can be determined by the decoding capability of that UE. The UE can decode the multiple SCI messages in an order of signal strength. For example, the device can decode a first SCI having the highest power, and then decode a second SCI having the second highest power strength, until the maximum SCI decoding capability of the UE is reached.

### 2) The Receiving UE Reporting its SCI Decoding Capability to the Transmitting UE

The receiving UE can report its SCI decoding capability to the transmitting UE. This information can assist the transmitting UE to make resource selection.

### 3) The Transmitting UE Performs Resource Selection Based on the Receiving UE's SCI Decoding Capability

With knowledge of the receiving UE's SCI decoding capability, the transmitting UE can make adjustments accordingly or adopt a different resource selection strategy. Two examples are provided below.

A) A Shorter Selection Window and/or a Larger SL Resource Exclusion RSRP Threshold

As mentioned above, the transmitting UE select resources for transmission within a selection window. If a reserved resource within the selection window has an SL-RSRP above a specific threshold, the transmitting UE excludes it from being considered as a candidate resource.

Since the receiving UE has the capability to decode multiple SCI messages on a single PSCCH resource, the receiving UE is resilient to potential interference or collided SL transmission. That means that the receiving UE is able to decode the desired SCI even if its signal is not the strongest one on the corresponding SL resource at the receiving UE side. Thus, the transmitting UE can adopt a shorter selection window length and/or a rigider (or higher) resource exclusion threshold in resource selection. As a result, the delay in the desired transmission can be effectively reduced.

### B) Preemption of SL Transmission

Given the receiving UE's multiple SCI decoding capability, the transmitting UE can decide to preempt other SL device's transmission to transmit with packet with a higher priority. Since the receiving UE is able to decode multiple SCI messages on a single control channel resource, good decoding performance is still feasible in collided transmission.

### 4) The Transmitting UE Performs Resource Selection Based on its Multiple SCI Sensing Result

While the transmitting UE performs sensing within the SL sensing window, the capability to decode multiple SCI messages is beneficial to collect more resource reservation information from other SL devices. During resource selection, the resource reservation information can be used to make better selection decisions and avoid collisions during transmissions. The problem of SCI decoding failure caused by hidden node interference also can be mitigated by the multiple SCI decoding capability of the transmitting UE and/or the receiving UE.

### V. Non-limiting Embodiments of the Multiple SCI Decoding Solution

Based on the design concepts above, several embodiments are illustrated below. These embodiments include four scenarios as follows:
Case 1: The receiving UE reports its decoding capability to the transmitting UE for resource selection
Case 2: The receiving UE performs sensing/decoding of multiple SCI messages to help the transmitting UE to select transmission resources
Case 3: The transmitting UE performs sensing/decoding of multiple SCI messages to select transmission resources
Case 4: The receiving UE reports its decoding capability to the transmitting UE for resource preemption

### 1. Case 1: The Receiving UE Reports its Decoding Capability to the Transmitting UE for Resource Selection

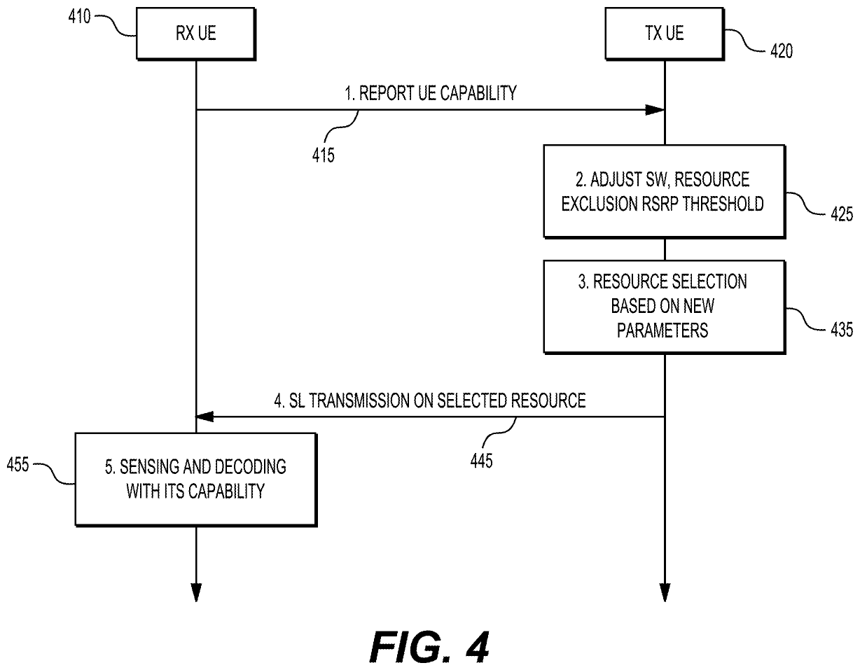

FIG. 4 shows an example of sidelink transmission between a transmitting device 420 and a receiving device 410 according to some embodiments of the disclosure. The detail descriptions of sequential steps are explained below.

### 1) Reporting the SCI Decoding Capability

At 415, the receiving UE 410 reports its SCI decoding capability to the transmitting UE 420. For instance, the SCI decoding capability can be the maximum SCI decoding number of the receiving UE 410 per PSCCH resource. Non-limiting examples of the SCI decoding capability can include the maximum number of SCIs for decoding per slot, per symbol, per sub-channel, per resource pool, per bandwidth part (BWP), and per band, the maximum SCI decoding number of the receiving UE 410 per link pair, the maximum SCI decoding number of the receiving UE 410 per transmitting UE, and the like.

2) Adjusting the Selection Window and/or the Resource Exclusion RSRP Threshold

Based on the decoding capability reported by the receiving UE 410, the transmitting UE 420 can adjust the resource selection window and/or the resource exclusion RSRP threshold at 425. For example, when the receiving UE 410 is capable to decode more SCIs per PSCCH resource, the transmitting UE 420 can use a shorter selection window and/or a larger resource exclusion RSRP threshold.

### 3) Resource Selection Based on the Adjusted Parameters

Based on the adjusted resource selection window and/or resource exclusion RSRP threshold, the transmitting UE 420 select transmission resources at 435. For example, since the receiving UE 410 is tolerant to transmission collisions, the transmitting UE 420 can make selection decisions in a more aggressive manner. As a result, the transmission can be carried out between the transmitting UE 420 and the receiving UE 410 with shorter latency.

### 4) Sidelink Transmission on the Selected Resource

At 445, the sidelink transmission is performed on the selected resource between the transmitting UE 420 and the receiving UE 410.

### 5) Multiple SCI Decoding at the Receiving UE Side

At 455, the receiving UE 410 can decode multiple SCI messages on a single PSCCH resource. Decoding of the multiple SCI messages can be conducted in the order of signal strength. Using the decoded SCI information, the receiving UE 410 can decode data transmitted on the data channel.

### 2. Case 2: The Receiving UE Performs Channel Sensing With its Multiple SCI Decoding Capability

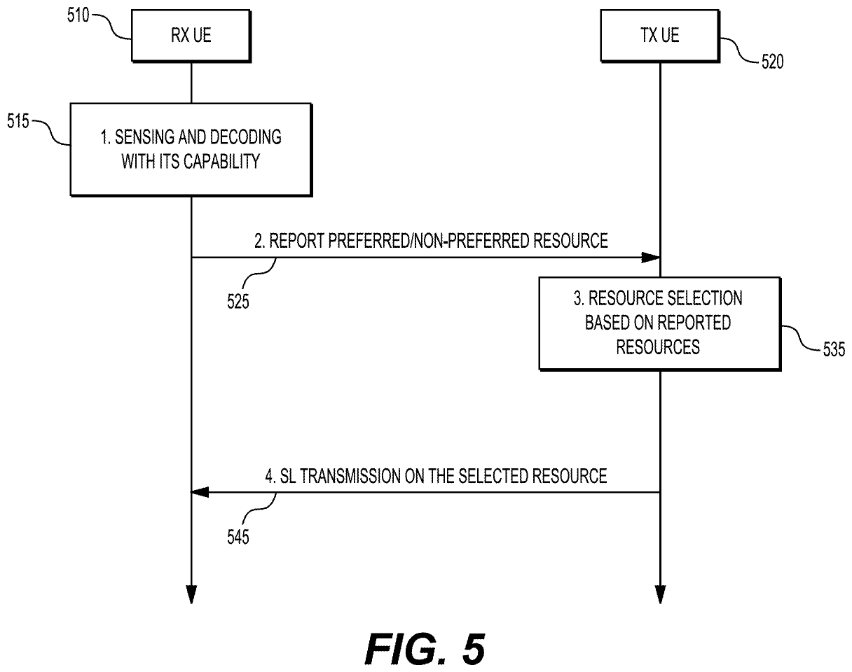

FIG. 5 shows an example of sidelink transmission between a transmitting device 520 and a receiving device 510 according to some embodiments of the disclosure. The detail descriptions of sequential steps are explained below.

### 1) Sensing and Decoding at the Receiving UE Side

At 515, the receiving UE 510 can perform channel sensing and decode multiple SCI messages on a single PSCCH resource. The decoding of multiple SCI messages can be conducted in the order of signal strength. Through SCI decoding, the receiving UE 510 can collect resource reservation information from nearby SL devices.

### 2) Reporting Preferred/Non-Preferred Resource(s) or Resource Collision(s)

At 525, based on the sensing and decoding result, the receiving UE 510 can generate an indication to its preferred/non-preferred resource(s) and/or any resource collision(s), and report this information to the transmitting UE 520.

### 3) Transmission Resource Selection

At 535, the transmitting UE 520 can make a resource selection decision, taking account of the preferred/non-preferred resource(s) and/or resource collision(s) reported by the receiving UE 510. By considering this information, the transmission between the transmitting UE 520 and the receiving UE 510 can be performed with a lower possibility of interference at the receiving UE side.

### 4) Sidelink Transmission on the Selected Resource

At 545, the sidelink transmission is performed on the selected resource between the transmitting UE 520 and the receiving UE 510.

### 3. Case 3: The Transmitting UE Performs Channel Sensing With its Multiple SCI Decoding Capability

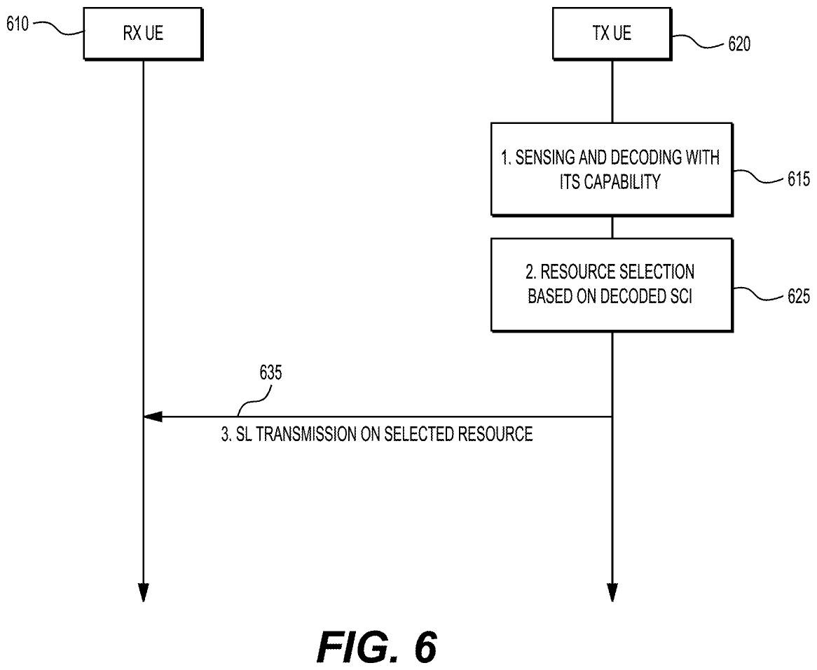

FIG. 6 shows an example of sidelink transmission between a transmitting device 620 and a receiving device 610 according to some embodiments of the disclosure. The detail descriptions of sequential steps are explained below.

### 1) Sensing and Decoding at the Transmitting UE Side

At 615, the transmitting UE 620 performs channel sensing and decodes multiple SCI messages on a single PSCCH resource. The decoding of multiple SCI messages can be conducted in the order of signal strength. Through SCI decoding, the transmitting UE 610 can collect resource reservation information from nearby SL devices.

### 2) Transmission Resource Selection Based on the Multiple SCI Decoding Result

Based on the sensing and decoding result, the transmitting UE 620 can select transmission resources at 625. With its ability to decode multiple SCI signals on a PSCCH resource, the transmitting UE 625 can gather more reservation information from nearby SL devices. This allows the transmitting UE 625 to make a more informed selection decision while avoiding potential interference.

### 3) Sidelink Transmission on the Selected Resource

At 635, the sidelink transmission is performed on the selected resource between the transmitting UE 620 and the receiving UE 610.

### 4. Case 4: The Receiving UE Reports its SCI Decoding Capability to the Transmitting UE for Resource Preemption

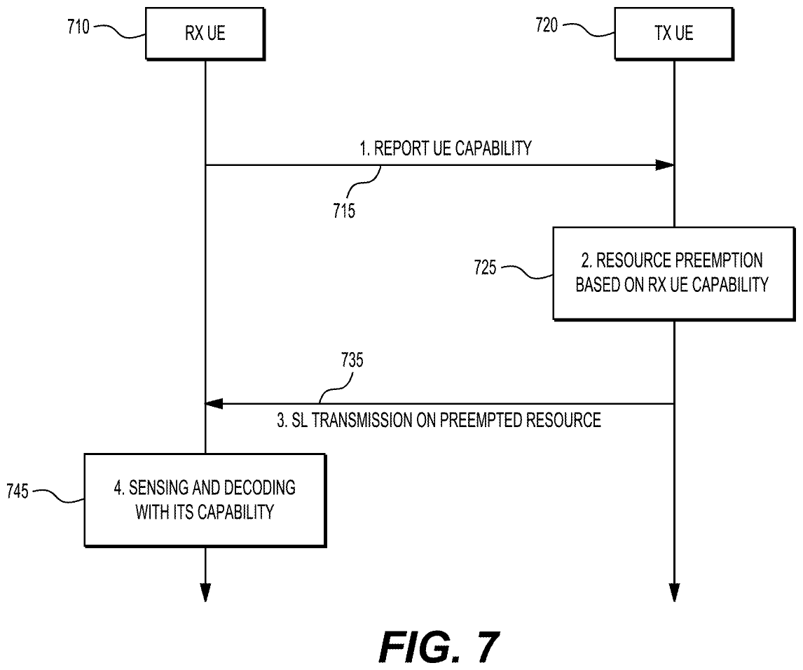

FIG. 7 shows an example of sidelink transmission between a transmitting device 720 and a receiving device 710 according to some embodiments of the disclosure. The detail descriptions of sequential steps are explained below.

### 1) Reporting the SCI Decoding Capability

At 715, the receiving UE 710 reports its SCI decoding capability (e.g. the maximum SCI decoding number per PSCCH resource) to the transmitting UE 720.

### 2) Preemption Decision

Based on the SCI decoding capability reported by the receiving UE 710, the transmitting UE 720 can decide at 725 to preempt a resource reserved by another SL device, if the receiving UE 710 is able to decode multiple SCI messages and the transmission to be performed by the transmitting UE 720 has a higher priority. Since the receiving UE 710 is resilient to transmission collisions, the transmitting UE 720 can transmit on the collided resource.

### 3) Sidelink Transmission on the Selected Resource

At 735, the sidelink transmission is performed on the selected resource between the transmitting UE 720 and the receiving UE 710.

### 4) Multiple SCI Decoding at the Receiving UE Side

At 745, the receiving UE 710 can decode multiple SCI messages on a single PSCCH resource. Decoding of the multiple SCI messages can be conducted in the order of signal strength. Using the decoded SCI information, the receiving UE 710 can decode data transmitted on the data channel.

### VI. Further Examples of SL-U Access Processes

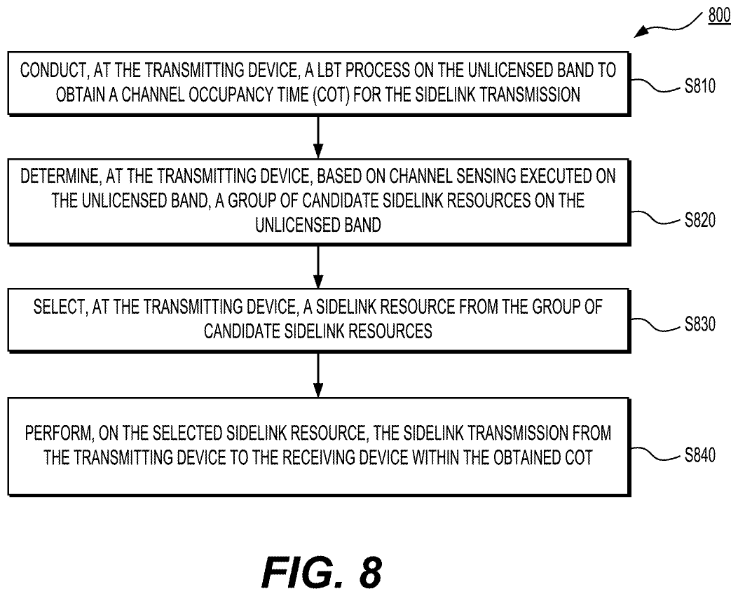

FIG. 8 shows a SL-U channel access process 800 according to embodiments of the disclosure. The process 800 can be performed at the sidelink UE pair. The process 800 can start from S810. It is noted that examples of processes (or procedures) disclosed herein can include multiple steps. In various embodiments, those steps can be performed in an order different from what is described in the examples. Also, not all of those steps are performed. In some embodiments, those steps may be performed in parallel.

At S810, an LBT process can be performed on the unlicensed band to obtain a COT for the sidelink transmission. The LBT process can be an LBT CAT4 procedure, which includes a random backoff process. Duration of the random backoff process can be determined by a randomly generated LBT counter (or LBT counter value).

At S820, based on a result from a sensing operation performed on the unlicensed band, a plurality of candidate sidelink resources can be determined on the unlicensed band within a sidelink resource selection window.

At S830, a sidelink resource can be selected from the plurality of candidate sidelink resources.

At S840, the sidelink transmission can be performed on the selected sidelink resource, from the transmitting device to the receiving device, within the obtained COT.

### VII. Apparatus and Non-Transitory Computer-Readable Medium

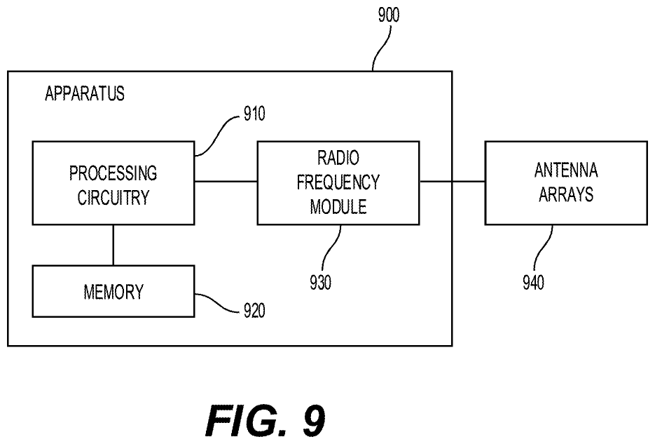

FIG. 9 shows an exemplary apparatus 900 according to embodiments of the disclosure. The apparatus 900 can be configured to perform various functions in accordance with one or more embodiments or examples described herein. Thus, the apparatus 900 can provide means for implementation of mechanisms, techniques, processes, functions, components, systems described herein. For example, the apparatus 900 can be used to implement functions of UEs or BSs in various embodiments and examples described herein. The apparatus 900 can include a general-purpose processor or specially designed circuits to implement various functions, components, or processes described herein in various embodiments. The apparatus 900 can include processing circuitry 910, a memory 920, and a radio frequency (RF) module 930.

In various examples, the processing circuitry 910 can include circuitry configured to perform the functions and processes described herein in combination with software or without software. In various examples, the processing circuitry 910 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 910 can be a central processing unit (CPU) configured to execute program instructions to perform various functions and processes described herein. Accordingly, the memory 920 can be configured to store program instructions. The processing circuitry 910, when executing the program instructions, can perform the functions and processes. The memory 920 can further store other programs or data, such as operating systems, application programs, and the like. The memory 920 can include non-transitory storage media, such as a read only memory (ROM), a random access memory (RAM), a flash memory, a solid state memory, a hard disk drive, an optical disk drive, and the like.

In an embodiment, the RF module 930 receives a processed data signal from the processing circuitry 910 and converts the data signal to beamforming wireless signals that are then transmitted via antenna arrays 940, or vice versa. The RF module 930 can include a digital to analog converter (DAC), an analog to digital converter (ADC), a frequency up converter, a frequency down converter, filters and amplifiers for reception and transmission operations. The RF module 930 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 940 can include one or more antenna arrays.

The apparatus 900 can optionally include other components, such as input and output devices, additional or signal processing circuitry, and the like. Accordingly, the apparatus 900 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
conducting, at a first user equipment (UE), a listen-before-talk (LBT) process on an unlicensed band to obtain a channel occupancy time (COT) for a sidelink transmission;
determining, at the first UE, based on channel sensing executed on the unlicensed band, a group of candidate sidelink resources on the unlicensed band, where each candidate side link resource is within a sidelink resource selection window, and does not have reservation that is associated with a Reference Signal Received Power (RSRP) higher than a predetermined resource exclusion RSRP threshold;
selecting, at the first UE, a sidelink resource from the group of candidate sidelink resources; and
performing, on the selected sidelink resource, the sidelink transmission from the first UE to a second UE, within the obtained COT,
wherein multiple Sidelink Control Information (SCI) messages are decoded at the first UE on a single Physical Sidelink Control Channel (PSCCH) resource.

2. The method of claim 1, further comprising:
receiving, from the second UE, an SCI decoding capability of the second UE; and
determining, based on the received SCI decoding capability of the second UE, at least one of a size of the sidelink resource selection window and a value of the RSRP threshold.

3. The method of claim 2, wherein
the higher the SCI decoding capability of the second UE is, the narrower the size of the sidelink resource selection window is, and
the higher the SCI decoding capability of the second UE is, the higher the value of the RSRP threshold is.

4. The method of claim 2, wherein the reported SCI decoding capability is indicated by one of:
a maximum SCI decoding number of the second UE per PSCCH resource,
a maximum number of SCIs for decoding per slot,
a maximum number of SCIs for decoding per symbol,
a maximum number of SCIs for decoding per sub-channel,
a maximum number of SCIs for decoding per resource pool,
a maximum number of SCIs for decoding per bandwidth part (BWP),
a maximum number of SCIs for decoding per band,
a maximum SCI decoding number of the second UE per link pair, and
a maximum SCI decoding number of the second UE per receiving device.

5. The method of claim 1, wherein the decoding of the multiple SCI messages further comprises decoding the multiple SCI messages in an order of signal strength, such that an SCI message with a higher signal strength is decoded before an SCI message with a weaker signal strength.

6. The method of claim 1, further comprising:
decoding, at the first UE, multiple SCI messages on a single PSCCH resource, to collect resource reservation information from nearby sidelink UEs;
generating, at the first UE, selection assistance information, based on the collected resource reservation information; and
reporting, from the first UE to a third UE, the generated selection assistance information for a sidelink reception from the third UE.

7. The method of claim 6, wherein the generating step further comprises generating, at the first UE, an indication of a preferred resource, as the generated selection assistance information, and
the preferred resource is a resource that is identified, based on the collected selection assistance information, as preferred by the first UE for the sidelink reception.

8. The method of claim 6, wherein the generating step further comprises generating, at the first UE, an indication of a non-preferred resource, as the generated selection assistance information, and
the non-preferred resource is a resource that is identified, based on the collected resource reservation information, as not preferred by the first UE for the sidelink reception.

9. The method of claim 6, wherein the generating step further comprises generating, at the first UE, an indication of a collided resource, as the generated selection assistance information, and
the collided resource is a resource that is identified, based on the multiple SCI decoded on the PSCCH resource, as having a collision when the sidelink reception from the third UE is performed thereon.

10. The method of claim 1, further comprising:
receiving from the second UE, a report of selection assistance information indicating a preferred resource, a non-preferred resource, and/or a potentially collided resource; and
selecting, at the first UE, the sidelink resource from the group of candidate sidelink resources, based on the reported selection assistance information.

11. The method of claim 1, wherein the determining step further comprises:
executing, at the first UE, the channel sensing by decoding the multiple SCI messages on the single PSCCH resource, to collect resource reservation information from nearby sidelink UEs, and
determining, at the first UE, based on the collected resource reservation information, the group of candidate sidelink resources.

12. The method of claim 11, wherein the executing step further comprises decoding the multiple SCI messages in an order of signal strength, such that an SCI message with a higher signal strength is decoded before an SCI message with a weaker signal strength.

13. The method of claim 1, wherein the method further comprises:
receiving, from the second UE, an SCI decoding capability of the second UE; and
choosing, at the first UE, based on the received SCI decoding capability and a priority level of the sidelink transmission to be performed, a collided resource, as the selected sidelink resource, where the collided resource is reserved by a nearby sidelink UE.

14. An apparatus comprising circuitry configured to:
conduct, at a first user equipment (UE), a listen-before-talk (LBT) process on the unlicensed band to obtain a channel occupancy time (COT) for a sidelink transmission;
determine, at the first UE, based on channel sensing executed on an unlicensed band, a group of candidate sidelink resources on the unlicensed band, where each candidate side link resource is within a sidelink resource selection window, and does not have reservation that is associated with a Reference Signal Received Power (RSRP) higher than a predetermined resource exclusion RSRP threshold;
select, at the first UE, a sidelink resource from the group of candidate sidelink resources; and
perform, on the selected sidelink resource, the sidelink transmission from the first UE to a second UE, within the obtained COT,
wherein multiple Sidelink Control Information (SCI) messages are decoded at the first UE on a single Physical Sidelink Control Channel (PSCCH) resource.

15. The apparatus of claim 14, wherein the circuitry is further configured to:
receive, from the second UE, an SCI decoding capability of the second UE; and
determine, at least one of a size of the sidelink resource selection window and a value of the RSRP threshold, based on the received SCI decoding capability of the second UE.

16. The apparatus of claim 14, wherein the circuitry is further configured to decode the multiple SCI messages in an order of signal strength, such that an SCI message with a higher signal strength is decoded before an SCI message with a weaker signal strength.

17. The apparatus of claim 14, wherein the circuitry is further configured to:
decode, at the first UE, multiple SCI messages on a single PSCCH resource, to collect resource reservation information from nearby sidelink UEs;
generate, at the first UE, selection assistance information, based on the collected resource reservation information; and
report, from the first UE to a third UE, the generated selection assistance information for a sidelink reception from the third UE.

18. The apparatus of claim 14, wherein the circuitry is further configured to:
execute, at the first UE, the channel sensing by decoding the multiple SCI messages on the single PSCCH resource, to collect resource reservation information from nearby sidelink UEs; and
determine, at the first UE, based on the collected resource reservation information, the group of candidate sidelink resources.

19. The apparatus of claim 14, wherein the circuitry is further configured to:
receive, from the second UE, an SCI decoding capability of the second UE; and
choose, at the first UE, based on the received SCI decoding capability and a priority level of the sidelink transmission to be performed, a collided resource, as the selected sidelink resource, where the collided resource is reserved by a nearby sidelink UE.

20. A non-transitory computer-readable medium storing instructions that, when executed by a processor, cause the processor to perform a method comprising:
conducting, at a first user equipment (UE), a listen-before-talk (LBT) process on an unlicensed band to obtain a channel occupancy time (COT) for a sidelink transmission;
determining, at the first UE, based on channel sensing executed on the unlicensed band, a group of candidate sidelink resources on the unlicensed band, where each candidate side link resource is within a sidelink resource selection window, and does not have reservation that is associated with a Reference Signal Received Power (RSRP) higher than a predetermined resource exclusion RSRP threshold;
selecting, at the first UE, a sidelink resource from the group of candidate sidelink resources; and
performing, on the selected sidelink resource, the sidelink transmission from the first UE to a second UE, within the obtained COT,
wherein multiple Sidelink Control Information (SCI) messages are decoded at the first UE on a single Physical Sidelink Control Channel (PSCCH) resource.
